(19) United States
(12) Patent Application Publication
(10) Pub. No.: US 2012/0327206 A1
(43) Pub. Date: Dec. 27, 2012

(54) INFORMATION PROCESSING APPARATUS, COMPUTER IMPLEMENTED METHOD FOR PROCESSING INFORMATION AND NON-TRANSITORY MEDIUM STORING A COMPUTER PROGRAM FOR PROCESSING INFORMATION

(75) Inventor: Nobuhiro Nonogaki, Tokyo (JP)

(73) Assignee: KABUSHIKI KAISHA TOSHIBA, Tokyo (JP)

(21) Appl. No.: 13/418,184

(22) Filed: Mar. 12, 2012

(30) Foreign Application Priority Data
Jun. 24, 2011 (JP) 2011-141029

(51) Int. Cl. G06K 9/46; H04N 7/18

(52) U.S. Cl. 348/77; 382/195; 348/E07.085

(57) ABSTRACT

According to one embodiment, an information processing apparatus includes a camera, first and second feature region detectors, a plural operation command generators and a selector. The camera obtains an image of at least a part of a human body and generates image data of the obtained image. The first feature region detector detects a first feature region including a feature part of the human body from the image data and generates first feature region information defining the first feature region. The second feature region detector generates second feature region information defining a second feature region corresponding to the first feature region in a virtual space based on the first feature region information. The operation command generators generate operation commands corresponding to a plurality of partial spaces in the virtual space. The selector selects one of the operation command generators based on the second feature region information.

### CROSS REFERENCE TO RELATED APPLICATIONS

This application is based upon and claims the benefit of priority from the prior Japanese Patent Application No. 2011-141029, filed on Jun. 24, 2011, the entire contents of which are incorporated herein by reference.

### FIELD

Embodiments described herein relate generally to an information processing apparatus, a computer implemented method for processing information and a medium storing a computer program for processing information.

### BACKGROUND

Conventionally, there is known an information processing apparatus (for example, cellular phones) that includes an input device such as a touch panel or a keyboard as well as an acceleration sensor detecting static acceleration. Such information processing apparatus controls movement of a cursor or display of a 3D (three-dimensional) image in accordance with the output of the acceleration sensor.

Moreover, there is known a user interface apparatus that obtains the facial image of a user, estimates the direction of the user's face based on the obtained facial image, and executes a predetermined input process in accordance with the estimated direction of the face.

However, the direction of a human's face has high flexibility in a horizontal direction, but has low flexibility in a vertical direction. For example, when the direction of the face is largely turned to the upper in the horizontal direction, a screen is out of the user's sight. That is, the technology of operating the information processing apparatus in accordance with only the direction of the face is degraded in operability.

### BRIEF DESCRIPTION OF THE DRAWINGS

FIG. 1 is a block diagram illustrating the information processing apparatus 10 of the first embodiment.

FIG. 2 is an explanatory diagram illustrating the body position calculator 122, the UI controller 124, and the application controller 126 realized by the controller 12 of the first embodiment.

FIG. 3 is a flowchart of application control of the first embodiment.

FIG. 4A is an explanatory diagram illustrating obtainment of the image of the user of the first embodiment.

FIG. 4B is an explanatory diagram illustrating the detection of the first feature region of the first embodiment.

FIG. 4C is an explanatory diagram illustrating the detection of the second feature region of the first embodiment.

FIG. 5 is a flowchart of the selection of the operation command generator 124B of the first embodiment.

FIG. 6 is a diagram illustrating an example of the assignment of the operation command generators 124B of the first embodiment.

FIG. 7A illustrates an example in which the center Or2 continues to be located in the partial space PS1 during times t1 and t2.

FIG. 7B illustrates an example in which the center Or2 located in the partial space PS1 at the time t1 is moved to the partial space PS2 at the time t2 and the center Or2 continues to be located in the partial space PS2 during times t2 and t3.

FIG. 8 is a diagram illustrating the data structure of the selection table of the first embodiment.

FIG. 9 is a diagram illustrating an example of the generation of the operation command of the first embodiment.

FIG. 10 is a diagram illustrating an example of the generation of operation commands of the second embodiment.

FIG. 11 is a diagram illustrating an example of the generation of the operation commands of the third embodiment.

FIG. 12 is a diagram illustrating an example of the generation of the operation commands of the fourth embodiment.

FIG. 13 is a diagram illustrating an example of the generation of the operation commands of the fifth embodiment.

### DETAILED DESCRIPTION

Embodiments will now be explained with reference to the accompanying drawings.

In general, according to one embodiment an information processing apparatus includes a camera, a first feature region detector, a second feature region detector, a plurality of operation command generators and a selector. The camera obtains an image of at least a part of a human body and generates image data of the obtained image. The first feature region detector detects a first feature region including a feature part of the human body from the image data and generates first feature region information defining the first feature region. The second feature region detector generates second feature region information defining a second feature region corresponding to the first feature region in a virtual space based on the first feature region information. The operation command generators generate operation commands corresponding to a plurality of partial spaces in the virtual space. The selector selects one of the operation command generators based on the second feature region information.

### First Embodiment

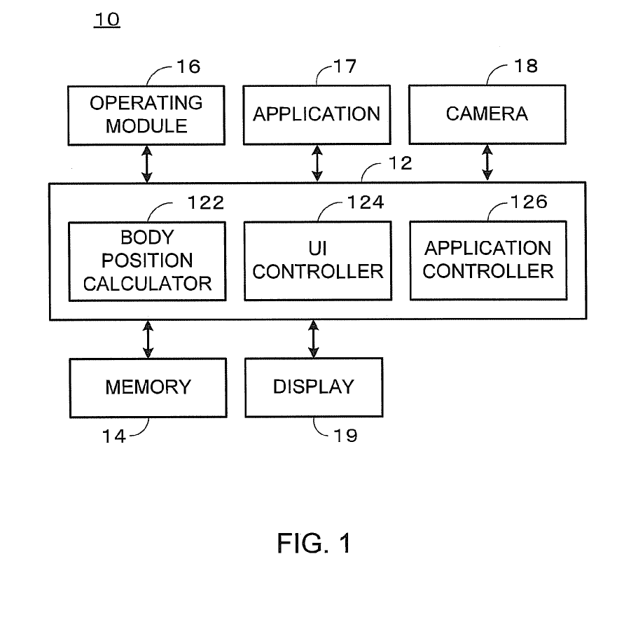

In a first embodiment, the basic functions of an information processing apparatus 10 will be described. FIG. 1 is a block diagram illustrating the information processing apparatus 10 of the first embodiment. The information processing apparatus 10 of the first embodiment includes a controller 12, a memory 14, an operating module 16, an application 17, a camera 18, and a display 19. The controller 12 controls the operation of the information processing apparatus 10. Various kinds of data are stored in the memory 14. The operating module 16 receives a user's instruction for the application 17. The application 17 realizes the functions of the information processing apparatus 10. The camera 18 obtains images (a plurality of still images or a moving image). The display 19 displays image data. The image data displayed on the display 19 is data that expresses an application image (such as a menu screen image, a text screen image, a planar figure image, a rendering image of a 3D computer graphic, and a reproduced image (a still image or a moving image)) of the application 17.

For example, the controller 12 is a computer processor. The controller 12 executes control programs stored in the memory 14 to realize the functions of a body position calculator 122, a UI (user interface) controller 124, and an application controller 126. Further, the controller 12 executes an application program stored in the memory 14 to realize the application 17.

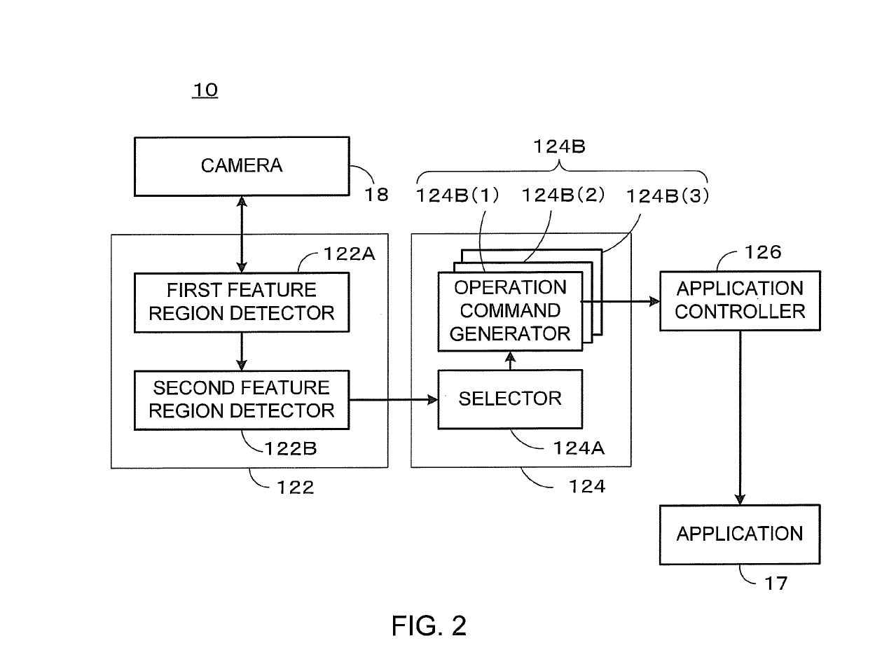

The functions realized by the controller 12 of the first embodiment will be described. FIG. 2 is an explanatory diagram illustrating the body position calculator 122, the UI controller 124, and the application controller 126 realized by the controller 12 of the first embodiment.

The body position calculator 122 includes a first feature region detector 122A and a second feature region detector 122B. The first feature region detector 122A detects a first feature region including a body feature part from image data of the image obtained by the camera 18. The first feature region is a region which is defined in a first space of the image data. The second feature region detector 122B detects a second feature region corresponding to the first feature region. The second feature region is a region which is defined in a second space different from the first space.

The UI controller 124 includes a selector 124A and a plurality of operation command generators 124B. In FIG. 2, for example, three operation command generators 124B are illustrated. The selector 124A selects one of the operation command generators 124B(1) to 124B(3) corresponding to the movement of a feature part among the plurality of operation command generators 124B. The selected operation command generators 124B generate operation commands corresponding to the movement of the feature part and output the generated operation commands to the application controller 126.

The application controller 126 controls the application 17 based on the operation commands outputted from the selected operation command generators 124B. As a result, the application 17 executes a process in response to the movement of the feature part of the user.

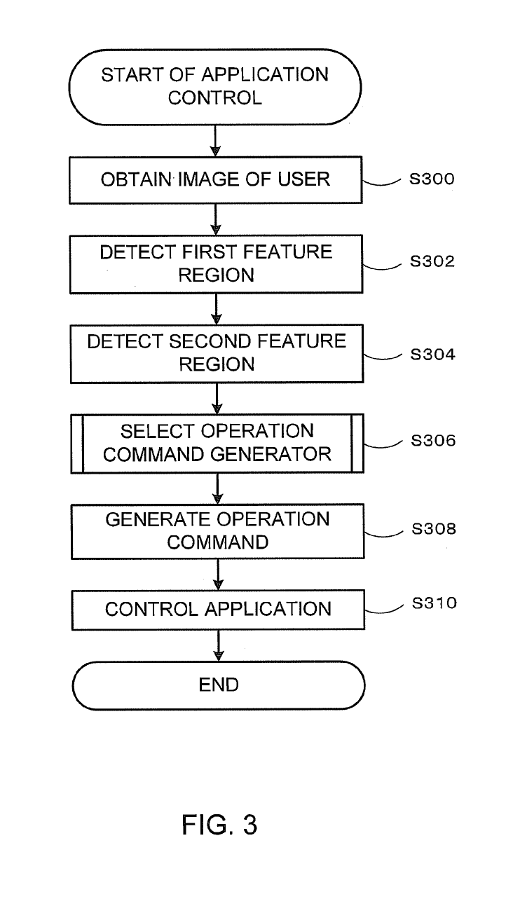

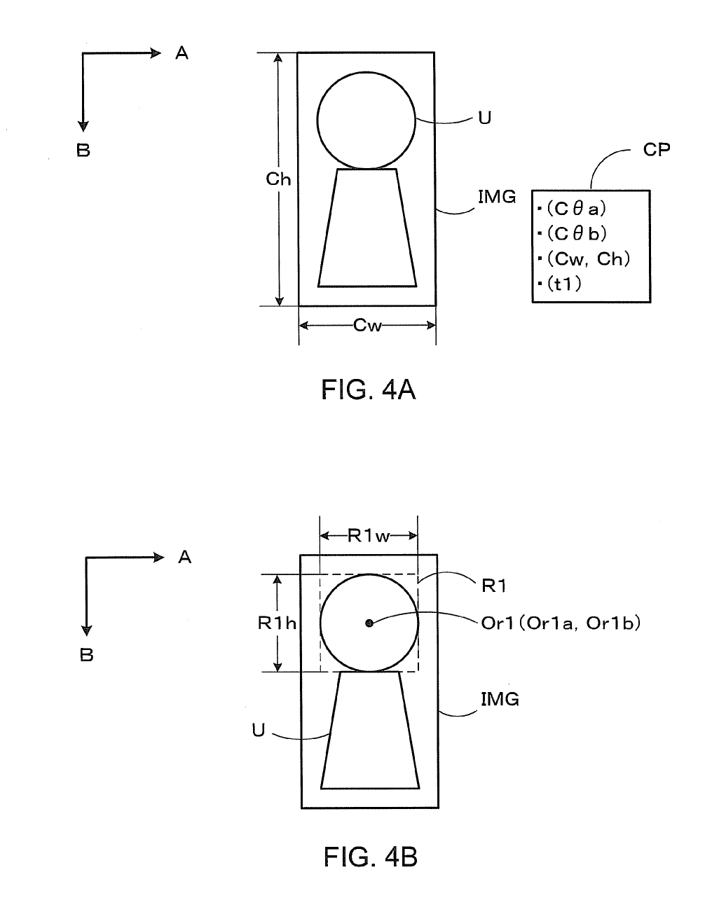

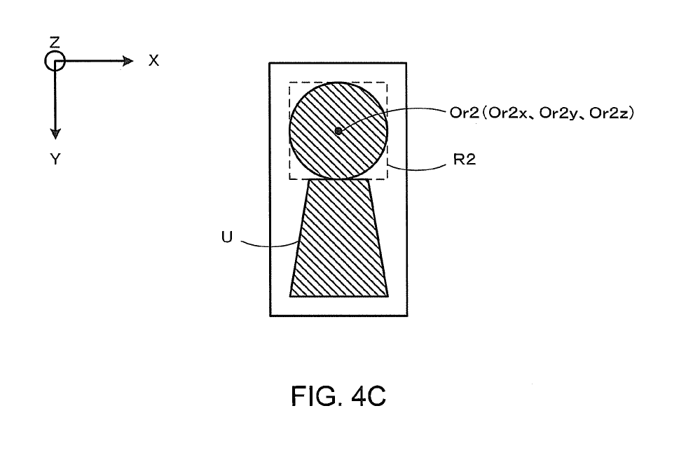

Information processing of the first embodiment will be described. FIG. 3 is a flowchart of application control of the first embodiment. The application control of the first embodiment is a process of controlling the application 17 in accordance with a movement of the user.

<S300> The first feature region detector 122A controls the camera 18 so that the camera 18 obtains the image of the user. The camera 18 obtains the image of the user and generates image data including the obtained image of the user. FIG. 4A is an explanatory diagram illustrating obtainment of the image of the user of the first embodiment. The camera 18 obtains the image of a user U, and generates image data IMG including the obtained image of the user U and camera parameters CP, as illustrated in FIG. 4A. The number of pixels of the image data IMG is Cw pixels in a horizontal direction (A direction) and Ch pixels in a vertical direction (B direction). The camera parameters CP include a horizontal view angle Cθa in the horizontal direction of the camera 18, a vertical view angle Cθb in the vertical direction of the camera 18, a pixel number Cw×Ch of the image data IMG, and a photographed time t at which the camera 18 obtains the image data IMG.

<S302> The first feature region detector 122A detects a first feature region R1 including a feature part of the human body of the user U from the image data IMG obtained in step S300 and generates first feature region information. The first feature region information is information which defines the first feature region R1.

FIG. 4B is an explanatory diagram illustrating the detection of the first feature region of the first embodiment. The first feature region R1 is a rectangular region including a feature part in an image space (first space) AB of the image data IMG. The first feature region information includes a horizontal size R1w, a vertical size R1h and coordinates (Or1a, Or1b) of a center Or1 of the first feature region R1. The unit of the parameters (R1a, R1b, (Or1w, Or1h)) of the first feature region information is a pixel.

For example, the first feature region detector 122A detects a feature part (for example, a head part of the user U) in the image data IMG by the use of a predetermined feature detection algorithm and generates the horizontal size, the vertical size and the coordinates of the center of the feature part as the first feature region information by the use of a template matching technique. More specifically, the first feature region detector 122A calculates a correlation value between a predetermined template image and an image expressed by the image data IMG while moving the template image and generates the horizontal size, the vertical size and the coordinates of the center of a region corresponding to a region with the highest correlation value as the first feature region information. The feature detection algorithm is one of an eigen space method, a partial space method, or the combination of a Haar like feature amount and an Adaboost algorithm.

<S304> The second feature region detector 122B generates second feature region information based on the first feature region information generated in step S302. The second feature region information is information which defines a second feature region R2 corresponding to the first feature region R1 in a virtual space (second space) different from the image space AB.

FIG. 4C is an explanatory diagram illustrating the detection of the second feature region of the first embodiment. The second feature region R2 is a region which corresponds to the first feature region R1 in a virtual space XYZ. The second feature region information includes the coordinates (Or2x, Or2y, Or2z) of a center Or2 of the second feature region R2. A unit of the parameters (Or2x, Or2y, Or2z) of the second feature region information is millimeter.

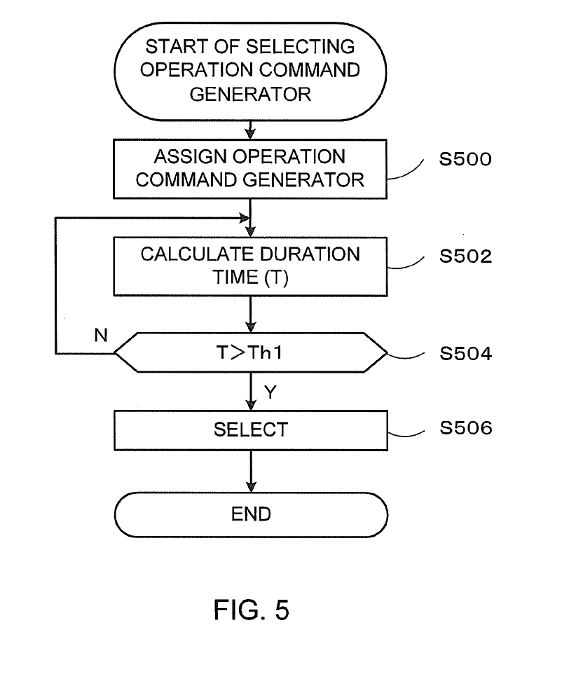

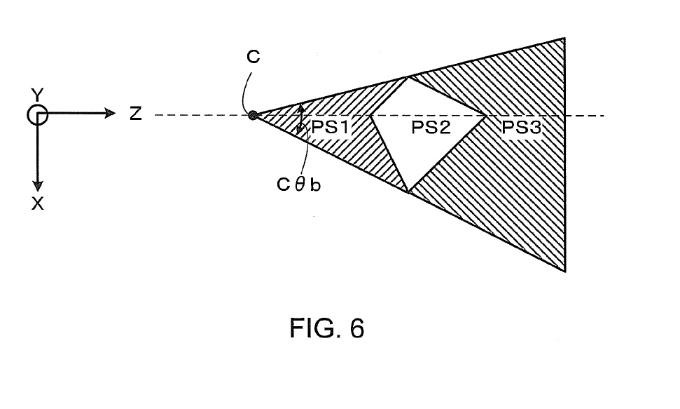

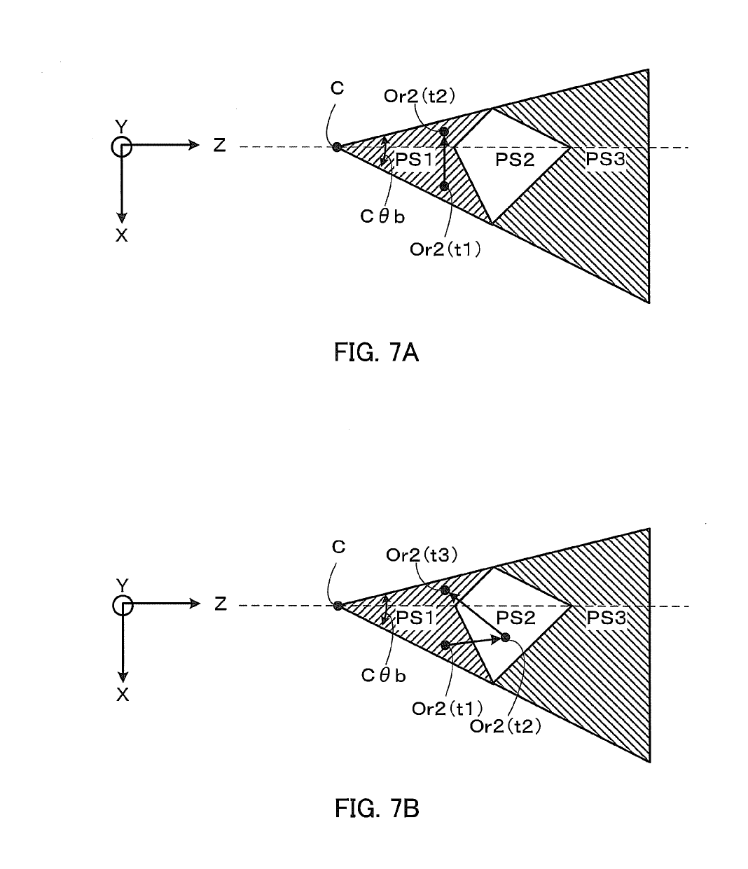

For example, the second feature region detector 122B generates the second feature region information using Equation 1. In Equation 1, Or1a and Or1b are coordinates in the horizontal direction (the A direction in FIG. 4A) and the vertical direction (the B direction in FIG. 4A) of the center Or1 of the first feature region, respectively. Uw and Uh are statistical values in the horizontal and vertical directions of the feature part of the user U, respectively. R1w and R1h are the sizes of the first feature region in the horizontal and vertical directions, respectively. Cw is the number of pixels of the image data IMG in the horizontal direction. Cθb is a vertical view angle of the camera 18. For example, when the feature part is a head part, Uw is a statistical value (157 mm×0.85 to 157 mm×1.15) of the head part in the horizontal direction and Uh is the statistical value (185 mm×0.87 to 185 mm×1.13) of the head part in the vertical direction.

$$Or 2 \{ \begin{matrix}Or 2 x = Or 1 a \times \frac{Uw}{R 1 w} \\ Or 2 y = Or 1 b \times \frac{Uh}{R 1 h} \\ Or 2 z = \frac{Cw}{2 tan \frac{C θ b}{2}} \times \frac{Uh}{R 1 h}\end{matrix} \qquad ( Equation 1 )$$

<S306> The selector 124A selects one of the plurality of operation command generators 124B(1) to 124B(3) based on the second feature region information. FIG. 5 is a flowchart of the selection of the operation command generator 124B of the first embodiment. The operation command generator 124B is selected based on the movement of the center Or2 in the virtual space XYZ.

<S500> The application controller 126 assigns the plurality of partial spaces in the virtual space XYZ to the plurality of operation command generators 124B, respectively, and notifies the selector 124A of the assignment result (a relation between the plurality of partial spaces and the plurality of operation command generators 124B). FIG. 6 is a diagram illustrating an example of the assignment of the operation command generators 124B of the first embodiment. The application controller 126 assigns three partial spaces PS1 to PS3 in the virtual space XYZ, which are defined by the vertical view angle Cθb of the camera 18 by using a point C corresponding to the position of the camera 18 as a center, to the plurality of operation command generators 124B(1) to 124B(3), respectively.

<S502> The selector 124A calculates a duration time T using the photographed times of the plurality of image data IMG. The duration time T is a time in which the center Or2 of the second feature region continues to be located in one identical space of the partial spaces PS1 to PS3. FIGS. 7A and 7B are explanatory diagrams illustrating the calculation of the duration time of the first embodiment.

FIG. 7A illustrates an example in which the center Or2 continues to be located in the partial space PS1 during times t1 and t2 (that is, during a period in which image data IMG1 is obtained and image data IMG2 is then obtained). As illustrated in FIG. 7A, the selector 124A counts the elapsed time from the time t1 when the center Or2 is moved in one partial space PS1 during the times t1 and t2. In this case, the duration time T at the time t2 is a counted value of t2−t1.

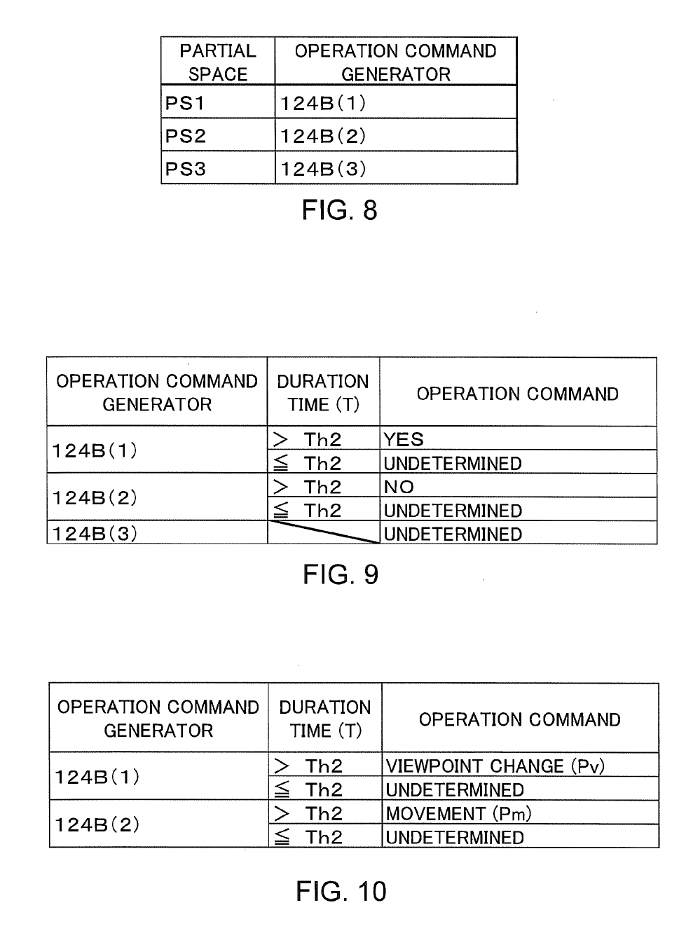

On the other hand, FIG. 7B illustrates an example in which the center Or2 located in the partial space PS1 at the time t1 (that is, the image data IMG1 is obtained) is moved to the partial space PS2 at the time t2 (that is, the image data IMG2 is obtained) and the center Or2 continues to be located in the partial space PS2 during times t2 and t3 (that is, during a period in which the image data IMG2 is obtained and image data IMG3 is obtained). As illustrated in FIG. 7B, when the center Or2 is moved from the partial space PS1 to the partial space PS2 (that is, the corresponding operation command is moved to another partial space) during the times t1 and t2, the selector 124A resets the elapsed time from the time t1 and counts an elapsed time from the time t2. In this case, the duration time T at the time t2 is zero. Thereafter, when the center Or2 is moved in one partial space PS2 during the times t2 and t3, the selector 124A counts the elapsed time from the time t2. In this case, the duration time T at the time t3 is the counted value of t3−t2.

<S504> The selector 124A compares the duration time T with a predetermined first time threshold value Th1. The first time threshold value Th1 is, for example, 500 msec. When the duration time T is greater than the first time threshold value Th1 (Yes in step S504), step S506 is executed. On the other hand, when the duration time T is equal to or less than the first time threshold value Th1 (No in step S504), the process returns to step S502. A loop from step S502 to step S504 is repeated until the duration time T exceeds the first time threshold value Th1.

<S506> The selector 124A generates a selection table based on the assignment result notified in step S500, and selects the operation command generator 124B corresponding to the partial space PS in which the center Or2 of the second feature region is located by the use of the generated selection table. FIG. 8 is a diagram illustrating the data structure of the selection table of the first embodiment. The selector 124A generates the selection table indicating the relation between the partial spaces PS1 to PS3 and the operation command generators 124B(1) to 124B(3) which correspond to the partial spaces PS1 to PS3, respectively. For example, the selector 124A selects the operation command generator 124B(1) corresponding to the partial space PS1 in the selection table, when the center Or2 of the second feature region is located in the partial space PS1 only during the duration time T greater than the first time threshold value Th1. When step S506 ends, step S308 of FIG. 3 is executed.

<S308> The operation command generator 124B selected in step S506 generates an operation command based on the movement of the center Or2 of the second feature region. The operation command generator 124B generates a predetermined operation command in accordance with a difference between the duration time T of the center Or2 of the second feature region and a predetermined second time threshold value Th2. The second time threshold value Th2 may be identical with or may be different from the first time threshold value Th1. FIG. 9 is a diagram illustrating an example of the generation of the operation command of the first embodiment.

When the operation command generator 124B(1) is selected in step S506 and the duration time T is greater than the second time threshold value Th2, the operation command generator 124B(1) generates an operation command of “YES”. On the other hand, when the operation command generator 124B(1) is selected in step S506 and the duration time T is equal to or less than the second time threshold value Th2, the operation command generator 124B(1) generates an operation command of “undetermined”. For example, when the user U moves his or her head part so that the center Or2 of the second feature region is located in the partial space PS1 for a time greater than the second time threshold value Th2, the operation command of “YES” is generated.

When the operation command generator 124B(2) is selected in step S506 and the duration time T is greater than the second time threshold value Th2, the operation command generator 124B(2) generates an operation command of “NO”. On the other hand, when the operation command generator 124B(2) is selected in step S506 and the duration time T is equal to or less than the second time threshold value Th2, the operation command generator 124B(2) generates the operation command of “undetermined”. For example, when the user U moves his or her head part so that the center Or2 of the second feature region is located in the partial space PS2 for a time greater than the first time threshold value Th1 and the second time threshold value Th2, the operation command of “NO” is generated. For example, when the user U nods forward, the operation command of “YES” is generated. When the user U shakes his or her head part right and left, the operation command of “NO” is generated. When the user U continues to move his or her head part, the operation command of “undetermined” is generated.

When the operation command generator 124B(3) is selected in step S506, the operation command generator 124B(3) generates the operation command of “undetermined” irrespective of the duration time T. For example, when the user U moves his or her head part so that the center Or2 of the second feature region is located in the partial space PS3, the operation command of “undetermined” is generated.

<S310> The application controller 126 outputs the operation command generated in step S308 to the application 17. Thus, the application 17 is controlled in accordance with the movement of the feature part of the user U.

According to the first embodiment, the center of the feature part of a human body is mapped to a virtual space and an operation command is generated based on the movement of the center and the duration time in which the center is located in one of the plurality of partial spaces of the virtual space. Therefore, the operability of the information processing apparatus 10 can be improved in response to a movement of the human body. Specifically, the user U can operate the application 17 without touching the operating module 16 just by moving a feature part photographed by the camera 18 in an actual space.

In the first embodiment, the coordinates of the center of the second feature region in the virtual space XYZ is calculated by using the statistical values Uw and Uh of the feature part of the user U. Therefore, the same calculation equation (Equation 1) can be applied to the plurality of users U.

In the first embodiment, the feature part is mapped from the image space AB to the virtual space XYZ. Therefore, the user U can enter continuous operation commands even when the user U stops.

In the first embodiment, the rule of generating the operation commands can be assigned to each partial space PS.

Incidentally, in the first embodiment, the example of the two operation command generators 124B(1) and 124B(2) has hitherto been described. However, the number of the operation command generators 124B is not limited to two. Further, the example of the virtual space XYZ including the plurality of planar (two-dimensional) partial spaces PS has hitherto been described to facilitate the description. However, the virtual space XYZ may include a plurality of stereoscopic (three-dimensional) partial spaces PS.

In the first embodiment, in step S304, the first feature region detector 122A may detect the first feature region with a shape which is different from the rectangular shape instead of detecting the first feature region with the rectangular shape. The first feature region detector 122A may detect the first feature region with, for example, an elliptical shape. In this case, the first feature region detector 122A generates the minor axis length, the major axis length, a rotation angle of the minor axis and the coordinates of the center of the elliptical shape circumscribed with a feature part of the user U as the first feature region information.

In the first embodiment, in step S500, the application controller 126 may use a virtual space XYZ with an arbitrary three-dimensional shape such as a spherical shape, a conical shape, or an elliptical shape instead of the triangular virtual space XYZ.

### Second Embodiment

In a second embodiment, the generation of the operation command will be described when a three-dimensional computer graphic is drawn as an example of an application function of the information processing apparatus 10. Further, the same description as that of the first embodiment will not be repeated. FIG. 10 is a diagram illustrating an example of the generation of operation commands of the second embodiment. The steps of obtaining the images of the user to selecting the operation command generators are the same as those of the first embodiment. Further, the step of controlling the application is the same as that of the first embodiment.

When the operation command generator 124B(1) is selected in step S506 and the duration time T is greater than the second time threshold value Th2, the operation command generator 124B(1) generates an operation command of “viewpoint change (Pv)” having a viewpoint parameter Pv. On the other hand, when the operation command generator 124B(1) is selected in step S506 and the duration time T is equal to or less than the second time threshold value Th2, the operation command generator 124B(1) generates an operation command of “undetermined”. For example, when the user U moves his or her head part so that the center Or2 of the second feature region is located in the partial space PS1 for a time greater than the second time threshold value Th2, a viewpoint of the three-dimensional computer graphic displayed on the display 19 is changed in accordance with the viewpoint parameter Pv.

The operation command generator 124B(1) generates the viewpoint parameter Pv based on the position of the center Or2 of the second feature region. The viewpoint parameter Pv includes three viewpoint angles θ, φ, and r defining the viewpoint of the three-dimensional computer graphic. For example, the operation command generator 124B(1) generates the viewpoint parameter Pv using Equation 2. In Equation 2, Or2x, Or2y, and Or2z are the X coordinate, the Y coordinate, and the Z coordinate of the center Or2 of the second feature region, respectively. Further, α, β, and γ are predetermined coefficients and δ is a predetermined integer. For example, when the head of the user U gets close to the camera 18, the three-dimensional computer graphic is expanded and displayed. When the head of the user U gets distant from the camera 18, the three-dimensional computer graphic is reduced in size and displayed.

$$Pv \{ \begin{matrix}θ = α \times Or 2 x \\ φ = β \times Or 2 y \\ r = γ \times Or 2 z + δ\end{matrix} \qquad ( Equation 2 )$$

On the other hand, when the operation command generator 124B(2) is selected in step S506 and the duration time T is greater than the second time threshold value Th2, the operation command generator 124B(2) generates an operation command of “movement (Pm)” having a movement parameter Pm. On the other hand, when the operation command generator 124B(2) is selected in step S506 and the duration time T is equal to or less than the second time threshold value Th2, the operation command generator 124B(2) generates an operation command of “undetermined”. For example, when the user U moves his or her head part so that the center Or2 of the second feature region is located in the partial space PS1 for a time greater than the first time threshold value Th1 and the second time threshold value Th2, at least a portion of the three-dimensional computer graphic displayed on the display 19 is changed in accordance with the movement parameter Pm.

The operation command generator 124B(1) generates the movement parameter Pm based on the position of the center Or2 of the second feature region. The movement parameter Pm includes a movement vector (Pmx, Pmy, Pmz) of at least a portion of the three-dimensional computer graphic. For example, the operation command generator 124B(1) generates the movement parameter Pm using Equation 3. In Equation 3, Or2x, Or2y, and Or2z are the X coordinate, the Y coordinate, and the Z coordinate of the center Or2 of the second feature region, respectively. Further, CGx, CGy, and CGz are the X coordinate, the Y coordinate, and the Z coordinate of at least the portion of the three-dimensional computer graphic. For example, when the user U moves his or her head part, the eyes of an avatar expressed by the three-dimensional computer graphic move to follow the head part of the user. In this way, it can be configured that the avatar of the three-dimensional computer graphic keeps looking at the user.

$$Pm \{ \begin{matrix}Pmx = CGx - Or 2 x \\ Pmy = CGy - Or 2 y \\ Pmz = CGz - Or 2 z\end{matrix} \qquad ( Equation 3 )$$

According to the second embodiment, the three viewpoint angles θ, φ, and r or the movement vector (Pmx, Pmy, Pmz) of at least the portion of the three-dimensional computer graphic are calculated by applying predetermined coefficients and integers to the coordinates of the center Or2 of the second feature region. Therefore, the user U can operate the three-dimensional computer graphic more smoothly by moving a feature part.

Further, in the second embodiment, the operation command generator 124B(2) may generate an operation command of “viewpoint fixation” irrespective of the duration time T, instead of generating the movement vector (Pmx, Pmy, Pmz) of at least the portion of the three-dimensional computer graphic. In this case, when the user U moves his or her head part so that the center Or2 of the second feature region is located in the partial space PS2 for a time greater than the first time threshold Th1, the viewpoint of the three-dimensional computer graphic displayed on the display 19 is fixed.

### Third Embodiment

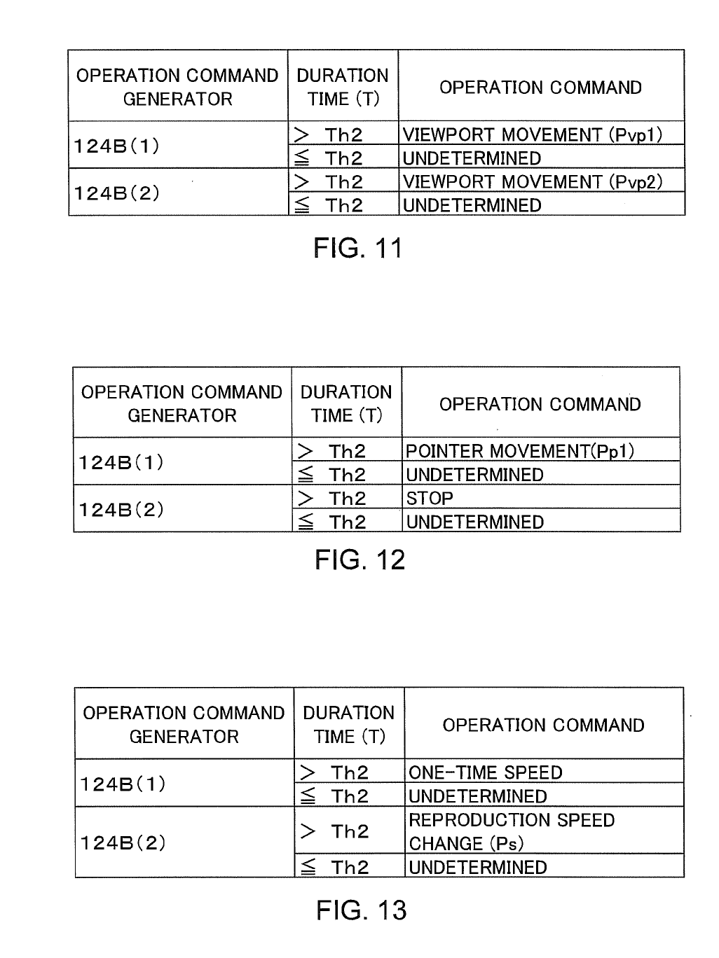

In a third embodiment, the generation of operation commands for browsing digital books will be described as an example of an application function of the information processing apparatus 10. The same descriptions as those of the first and second embodiments will not be repeated. FIG. 11 is a diagram illustrating an example of the generation of the operation commands of the third embodiment. The steps of obtaining the images of the user to selecting the operation command generators are the same as those of the first embodiment. Further, the step of controlling the application is the same as that of the first embodiment.

When the operation command generator 124B(1) is selected in step S506 and the duration time T is greater than the second time threshold value Th2, the operation command generator 124B(1) generates an operation command of “viewport movement (Pvp1)” having a first viewport parameter Pvp1. On the other hand, when the operation command generator 124B(1) is selected in step S506 and the duration time T is equal to or less than the second time threshold value Th2, the operation command generator 124B(1) generates an operation command of “undetermined”. For example, when the user U moves his or her head part so that the center Or2 of the second feature region is located in the partial space PS1 for a time greater than the first time threshold value Th1 and the second time threshold value Th2, a viewport of a digital book displayed on the display 19 is moved in accordance with the first viewport parameter Pvp1. The viewport is a point which defines a planar image to be displayed on a screen when the user virtually browses a part of a large planar image.

The operation command generator 124B(1) generates the first viewport parameter Pvp1 based on the position of the center Or2 of the second feature region. The first viewport parameter Pvp1 includes a change amount (ΔVx, ΔVy) of the coordinates of the center of the viewport and a change amount (ΔVw) of a range of the viewport. For example, the operation command generator 124B(1) generates the first viewport parameter Pvp1 using Equation 4. In Equation 4, Or2x, Or2y, and Or2z are the X coordinate, the Y coordinate, and the Z coordinate of the center Or2 of the second feature region, respectively. Further, α and β are predetermined coefficients and γ is a predetermined integer. In Equation 4, the change amount (ΔVx, ΔVy) of the coordinates of the center of the viewport is calculated by a square of the coordinates (Or2x, Or2y, Or2z) of the center Or2 of the second feature region. For example, when the user U moves his or her head part, the viewport is moved at high speed in a location distant from the center, whereas the viewport is moved at low speed in a location close to the center.

$$Pvp 1 \{ \begin{matrix}Δ Vx = {( α \times Or 2 x )}^{2} \\ Δ Vy = {( α \times Or 2 y )}^{2} \\ Δ Vw = ( β \times Or 2 z ) + γ\end{matrix} \qquad ( Equation 4 )$$

On the other hand, when the operation command generator 124B(2) is selected in step S506 and the duration time T is greater than the second time threshold value Th2, the operation command generator 124B(2) generates an operation command of “viewport movement (Pvp2)”. On the other hand, when the operation command generator 124B(2) is selected in step S506 and the duration time T is equal to or less than the second time threshold value Th2, the operation command generator 124B(2) generates an operation command of “undetermined”. For example, when the user U moves his or her head part so that the center Or2 of the second feature region is located in the partial space PS2 for a time greater than the first time threshold value Th1 and the second time threshold value Th2, the viewport of the digital book displayed on the display 19 moves in accordance with the second viewport parameter Pvp2.

The operation command generator 124B(2) generates the second viewport parameter Pvp2 based on the position of the center Or2 of the second feature region. The second viewport parameter Pvp2 includes a change amount (ΔVx, ΔVy) of the coordinates of the center of the viewport and a change amount (ΔVw) in a range of the viewport. For example, the operation command generator 124B(2) generates the second viewport parameter Pvp2 using Equation 5. In Equation 5, Or2x, Or2y, and Or2z are the X coordinate, the Y coordinate, and the Z coordinate of the center Or2 of the second feature region, respectively. Further, α and β are predetermined coefficients and γ is a predetermined integer. In Equation 5, the change amount (ΔVx, ΔVy) of the coordinates of the center of the viewport is calculated by the coordinates (Or2x, Or2y, Or2z) of the center Or2 of the second feature region. For example, when the user U moves his or her head part, the viewport moves at a constant speed in proportion to a distance from the center.

$$Pvp 2 \{ \begin{matrix}Δ Vx = ( α \times Or 2 x ) \\ Δ Vy = ( α \times Or 2 y ) \\ Δ Vw = ( β \times Or 2 z ) + γ\end{matrix} \qquad ( Equation 5 )$$

According to the third embodiment, the viewport of the digital book can be moved at a speed in accordance with the distance from the center or a constant speed irrespective of the distance from the center by applying the predetermined coefficients and integers to the coordinates and the range of the center Or2 of the second feature region. In particular, when the center Or2 of the second feature region is located in the partial region PS1, the viewport can be moved at high speed at a location distant from the center, whereas the viewport can be moved at low speed at a location close to the center. When the center Or2 of the second feature region is located in the partial region PS2, the viewport can be moved stably.

### Fourth Embodiment

In a fourth embodiment, the generation of operation commands for moving a mouse pointer will be described as an example of an application function of the information processing apparatus 10. The same descriptions as those of the first to third embodiments will not be repeated. FIG. 12 is a diagram illustrating an example of the generation of the operation commands of the fourth embodiment. The steps of obtaining the images of the user to selecting the operation command generators are the same as those of the first embodiment. Further, the step of controlling the application is the same as that of the first embodiment.

When the operation command generator 124B(1) is selected in step S506 and the duration time T is greater than the second time threshold value Th2, the operation command generator 124B(1) generates an operation command of “pointer movement (Pp1)” having a pointer parameter Pp. On the other hand, when the operation command generator 124B(1) is selected in step S506 and the duration time T is equal to or less than the second time threshold value Th2, the operation command generator 124B(1) generates an operation command of “undetermined”. For example, when the user U moves his or her head part so that the center Or2 of the second feature region is located in the partial space PS1 for a time greater than the first time threshold value Th1 and the second time threshold value Th2, a mouse pointer displayed on the display 19 is moved in accordance with the pointer parameter Pp.

The operation command generator 124B(1) generates the pointer parameter Pp based on the position of the center Or2 of the second feature region. The pointer parameter Pp includes a change amount (Δx, Δy) of the X and Y directions. For example, the operation command generator 124B(1) generates the pointer parameter Pp using Equation 6. In Equation 6, Or2x, Or2y, and Or2z are the X coordinate, the Y coordinate, and the Z coordinate of the center Or2 of the second feature region, respectively. Further, α is a predetermined coefficient and βth is a predetermined threshold value. In Equation 6, the change amount (Δx, Δy) of the coordinates of the mouse pointer is determined by a difference between the coordinates (Or2x, Or2y) of the center Or2 of the second feature region and the threshold value βth. For example, when the user U moves his or her head part, the mouse pointer is accelerated as the mouse pointer becomes distant from the center, whereas the mouse pointer is decelerated as the mouse pointer becomes close to the center. When the distance from the center is within a predetermined range, the mouse pointer stops.

$$Pp \{ \begin{matrix}Δ x = \{ \begin{matrix}α \times Or 2 x & if \vert Or 2 x \vert > β th \\ 0 & otherwise\end{matrix} \\ Δ y = \{ \begin{matrix}α \times Or 2 y & if \vert Or 2 y \vert > β th \\ 0 & otherwise\end{matrix}\end{matrix} \qquad ( Equation 6 )$$

On the other hand, when the operation command generator 124B(2) is selected in step S506 and the duration time T is greater than the second time threshold value Th2, the operation command generator 124B(2) generates an operation command of “stop”. On the other hand, when the operation command generator 124B(2) is selected in step S506 and the duration time T is equal to or less than the second time threshold value Th2, the operation command generator 124B(2) generates an operation command of “undetermined”. For example, when the user U moves his or her head part so that the center Or2 of the second feature region is located in the partial space PS2 for a time greater than the first time threshold value Th1 and the second time threshold value Th2, the mouse pointer is stopped.

According to the fourth embodiment, the mouse pointer can be accelerated, decelerated, or stopped in accordance with the distance from the center by calculating the pointer parameter Pp based on the relation between the coordinates (Or2x, Or2y) of the center Or2 of the second feature region and the threshold value βth. In particular, the usability can be improved by the threshold value βth when the distance between the head part of the user U and the center is within a predetermined range.

### Fifth Embodiment

In a fifth embodiment, the generation of operation commands for reproducing a moving image will be described as an example of an application function of the information processing apparatus 10. The same descriptions as those of the first to fourth embodiments will not be repeated. FIG. 13 is a diagram illustrating an example of the generation of the operation commands of the fifth embodiment. The steps of obtaining the images of the user to selecting the operation command generators are the same as those of the first embodiment. Further, the step of controlling the application is the same as that of the first embodiment.

When the operation command generator 124B(1) is selected in step S506 and the duration time T is greater than the second time threshold value Th2, the operation command generator 124B(1) generates an operation command of “one-time speed”. On the other hand, when the operation command generator 124B(1) is selected in step S506 and the duration time T is equal to or less than the second time threshold value Th2, the operation command generator 124B(1) generates an operation command of “undetermined”. For example, when the user U moves his or her head part so that the center Or2 of the second feature region is located in the partial space PS1 for a time greater than the first time threshold value Th1 and the second time threshold value Th2, the moving image is reproduced at one-time speed.

On the other hand, when the operation command generator 124B(2) is selected in step S506 and the duration time T is greater than the second time threshold value Th2, the operation command generator 124B(2) generates an operation command of “reproduction speed change (Ps)” having a speed parameter Ps. On the other hand, when the operation command generator 124B(2) is selected in step S506 and the duration time T is equal to or less than the second time threshold value Th2, the operation command generator 124B(2) generates an operation command of “undetermined”. For example, when the user U moves his or her head part so that the center Or2 of the second feature region is located in the partial space PS2 for a time greater than the first time threshold value Th1 and the second time threshold value Th2, the reproduction speed of the moving image is changed in accordance with the speed parameter Ps.

The operation command generator 124B(2) generates the speed parameter Ps based on the position of the center Or2 of the second feature region. For example, the operation command generator 124B(2) generates the speed parameter Ps using Equation 7. In Equation 7, Or2x and Or2z are the X coordinate and the Z coordinate of the center Or2 of the second feature region, respectively. Further, α, β, γ, and δ are predetermined integers. In Equation 7, the speed parameter Ps is determined in accordance with the coordinates (Or2x, Or2z) of the center Or2 of the second feature region. For example, when the user U moves his or her head part right and left at a position distant from the camera 18, the reproduction speed is changed in accordance with the position of the head part. When the user U moves his or her head part at a position close to the camera 18, the reproduction speed becomes one-time speed.

$$Ps = \{ \frac{α \times Or 2 x + β}{γ \times Or 2 z + δ} \qquad ( Equation 7 )$$

According to the fifth embodiment, the reproduction speed can be controlled in accordance with the distance from the center by calculating the speed parameter Ps based on the coordinates (Or2x, Or2z) of the center Or2 of the second feature region.

The fifth embodiment can be applied not only to the reproduction speed of a moving image but also to the control of the reproduction speed of music.

At least a portion of the information processing apparatus 10 according to the above-described embodiments may be composed of hardware or software. When at least a portion of the information processing apparatus 10 is composed of software, a program for executing at least some functions of the information processing apparatus 10 may be stored in a recording medium, such as a flexible disk or a CD-ROM, and a computer may read and execute the program. The recording medium is not limited to a removable recording medium, such as a magnetic disk or an optical disk, but it may be a fixed recording medium, such as a hard disk or a memory.

In addition, the program for executing at least some functions of the information processing apparatus 10 according to the above-described embodiment may be distributed through a communication line (which includes wireless communication) such as the Internet. In addition, the program may be encoded, modulated, or compressed and then distributed by wired communication or wireless communication such as the Internet. Alternatively, the program may be stored in a recording medium, and the recording medium having the program stored therein may be distributed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An information processing apparatus comprising:
a camera configured to obtain an image of at least a part of a human body and to generate image data of the obtained image;
a first feature region detector configured to detect a first feature region comprising a feature part of the human body from the image data and to generate first feature region information defining the first feature region;
a second feature region detector configured to generate second feature region information defining a second feature region corresponding to the first feature region in a virtual space based on the first feature region information;
a plurality of operation command generators configured to generate operation commands corresponding to a plurality of partial spaces in the virtual space; and
a selector configured to select one of the operation command generators based on the second feature region information.

2. The apparatus of claim 1,
wherein the second feature region information comprises a coordinate of a center of the second feature region.

3. The apparatus of claim 1,
wherein the selector selects one of the operation command generators based on the partial space in which the center of the second feature region is located and a duration time in which the second feature region continues to be located in the partial space.

4. The apparatus of claim 2,
wherein the selector selects one of the operation command generators based on the partial space in which the center of the second feature region is located and a duration time in which the second feature region continues to be located in the partial space.

5. The apparatus of claim 3,
wherein the selector compares the duration time with a predetermined time threshold value and selects one of the operation command generators when the duration time is greater than the predetermined time threshold value.

6. The apparatus of claim 4,
wherein the selector compares the duration time with a predetermined time threshold value and selects one of the operation command generators when the duration time is greater than the predetermined time threshold value.

7. The apparatus of claim 3,
wherein the camera further generates camera parameters comprising a photographed time at which the image data is obtained, and
wherein the selector calculates a difference between the photographed times of two pieces of image data as the duration time.

8. The apparatus of claim 4,
wherein the camera further generates camera parameters comprising a photographed time at which the image data is obtained, and
wherein the selector calculates a difference between the photographed times of two pieces of image data as the duration time.

9. The apparatus of claim 1,
wherein the first feature region detector detects a first feature region comprising a head part as the feature part of the human body, and
wherein the second feature region detector generates the second feature region information using a value about the head part.

10. A computer implemented method for processing information, the method comprising:
obtaining an image of at least a part of a human body;
generating image data of the obtained image;
detecting a first feature region comprising a feature part of the human body from the image data;
generating first feature region information defining the first feature region;
generating second feature region information defining a second feature region corresponding to the first feature region in a virtual space based on the first feature region information; and
selecting one of a plurality of operation commands corresponding to a plurality of partial spaces in the virtual space.

11. The method of claim 10,
wherein the second feature region information comprises a coordinate of a center of the second feature region.

12. The method of claim 10,
wherein in selecting one of the operation commands, one of the operation commands is selected on the basis of the partial space in which the center of the second feature region is located and a duration time in which the second feature region continues to be located in the partial space.

13. The method of claim 11,
wherein in selecting one of the operation commands, one of the operation commands is selected on the basis of the partial space in which the center of the second feature region is located and a duration time in which the second feature region continues to be located in the partial space.

14. The method of claim 12,
wherein in selecting one of the operation commands, the duration time is compared with a predetermined time threshold value and one of the operation commands is selected when the duration time is greater than the predetermined time threshold value.

15. The method of claim 13,
wherein in selecting one of the operation commands, the duration time is compared with a predetermined time threshold value and one of the operation commands is selected when the duration time is greater than the predetermined time threshold value.

16. The method of claim 12,
wherein in obtaining the image, camera parameters are generated, the camera parameters comprising a photographed time at which the image data is obtained, and
wherein in selecting one of the operation commands, a difference between the photographed times of two pieces of image data is calculated as the duration time.

17. The method of claim 13,
wherein in obtaining the image, camera parameters are generated, the camera parameters comprising a photographed time at which the image data is obtained, and
wherein in selecting one of the operation commands, a difference between the photographed times of two pieces of image data is calculated as the duration time.

18. The method of claim 10,
wherein in detecting the first feature region, a first feature region is detected, the first feature region comprising a head part as the feature part of the human body, and
wherein in generating the second feature region information, the second feature region information generated by using a value about the head part.

19. A non-transitory medium storing a computer program for processing information, the program comprising:
obtaining an image of at least a part of a human body;
generating image data of the obtained image;
detecting a first feature region comprising a feature part of the human body from the image data;
generating first feature region information defining the first feature region;
generating second feature region information defining a second feature region corresponding to the first feature region in a virtual space based on the first feature region information; and
selecting one of a plurality of operation commands corresponding to a plurality of partial spaces in the virtual space.

20. The medium of claim 19,
wherein the second feature region information comprises a coordinate of a center of the second feature region.
